(19) United States
(12) Patent Application Publication
(10) Pub. No.: US 2007/0069169 A1
(43) Pub. Date: Mar. 29, 2007

(54) Touch-flow water supply apparatus

(76) Inventor: Hui-Huang Lin, Hemei Township (TW)

Correspondence Address: John S. Egbert;Egbert Law Offices, 412 Main Street, 7th Floor, Houston, TX, 77002, US

(21) Appl. No.: 11/235,488

(22) Filed: Sep. 27, 2005

(51) Int. Cl. F16K 31/02

(52) U.S. Cl. 251/129.04

(57) ABSTRACT

The present invention is a water supply apparatus. A conventional water supply apparatus is mostly based on rotary and lever, which creates inconvenience. Also, there is a problem like inability to control the time of water supply. The primary features of the apparatus are connecting the touch sensory controller to the water supply apparatus, and the channel of the water supply apparatus having an electronic control valve, using the touch sensory controller to control the electronic control valve by circuit controller, and switch the water supply apparatus. The power electronic control valve needed may be supplied by the set of battery on the water supply apparatus or using external power. The operation and control of the water supply apparatus is more convenient and practical.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a water supply apparatus, and more particularly to a design that supplies water with a touch-flow water supply apparatus.

### BACKGROUND OF THE INVENTION

Take the faucet of the conventional water supply apparatus for example, the water supply valve is usually a rotary knob or lever, because it needs a human hand to touch the handle and operate it with force, therefore, this structure creates sanitary problems in the public area, and the handle can be easily broken because someone may use it with improper force. Based on this reason, even though some of the business has developed faucets that are electronic controlled with infrared sensor to supply and shut off water automatically, except, because of the module and time for water flow is fixed inflexibly, therefore, if it is applied to regular home environment, it may not be applicable because of its inflexibility.

Moreover, in terms of the water supply apparatus for the spray gun, the conventional spray gun usually supplies water by holding down the hand, in the process as such, people's hand must hold down the handle for a long time, therefore, it creates disadvantage such as inconvenience in operating.

Thus, to overcome the aforementioned problems of the prior art, it would be an advancement if the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

1. The preferred embodiment of the present invention primarily connects the touch sensory controller 30 to the structure of water supply apparatus, and an electronic control valve 20 is placed on the channel of the water supply apparatus, then design of the use touch sensory controller to control the switch of the electronic control valve and to turn the water apparatus on and for, so that the water supply apparatus is easy to control, and more convenient and more practical.

2. Another embodiment of the present invention shows the water supply apparatus 50 with touch-flow design, and it can also be added onto the existing water supply unit 60, and the water supply apparatus 50 has a connector 51 that can be connected to the water outlet 61 of the water supply unit, and the other end of water supply apparatus has a water outlet 52, so that the electronic control valve can be placed on the channel of water supply apparatus; place the touch sensor control and the power supply on the water supply apparatus; and by so doing, the existing water supply unit (such as faucet) can be added and operated by touch.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the preferred embodiment of the present invention.

FIG. 2 shows a side elevation view and isolated sectional view of the preferred embodiment of the present invention when the touch sensory controller is not pressed.

FIG. 3 shows another side elevation view and isolated sectional view of the preferred embodiment of the present invention when the touch sensory controller is pressed.

FIG. 4 shows a side sectional view of another embodiment of the touch sensory controller of the present invention.

FIG. 5 shows another side sectional view of an embodiment of the water supply apparatus of the present invention.

FIG. 6 shows still another side sectional view of an embodiment of the water supply apparatus of the present invention.

FIG. 7 shows another side sectional view of an embodiment of the water supply apparatus of the present invention.

FIG. 8 shows a side elevation view of an embodiment of the water supply apparatus that is added onto the existing water supply unit.

FIG. 9 shows a side elevation view of the second embodiment of the water supply apparatus that is added onto the existing water supply unit.

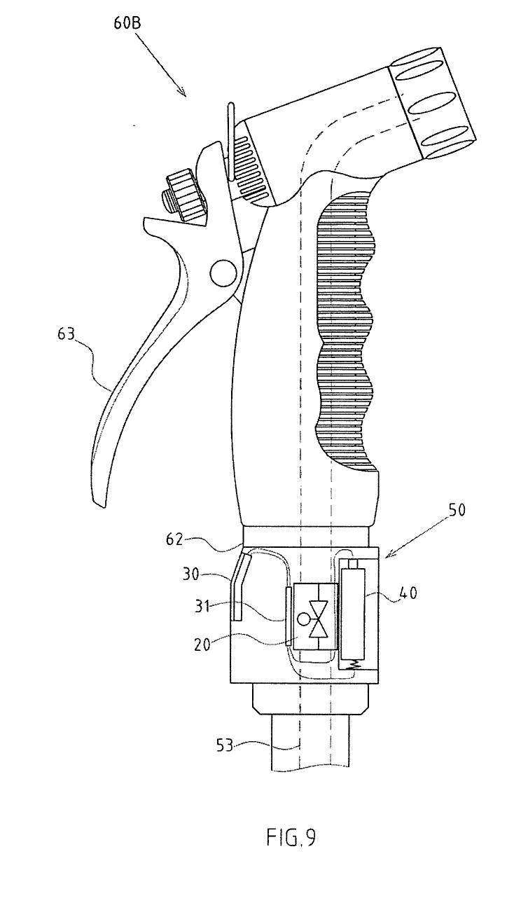

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

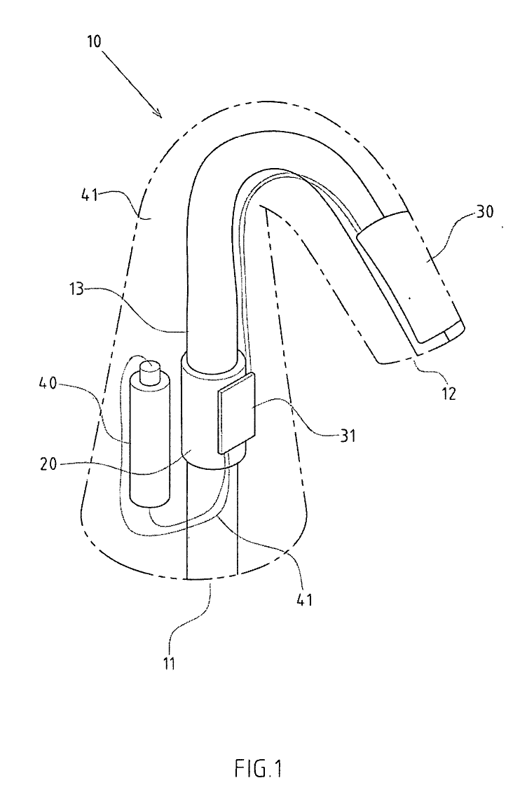

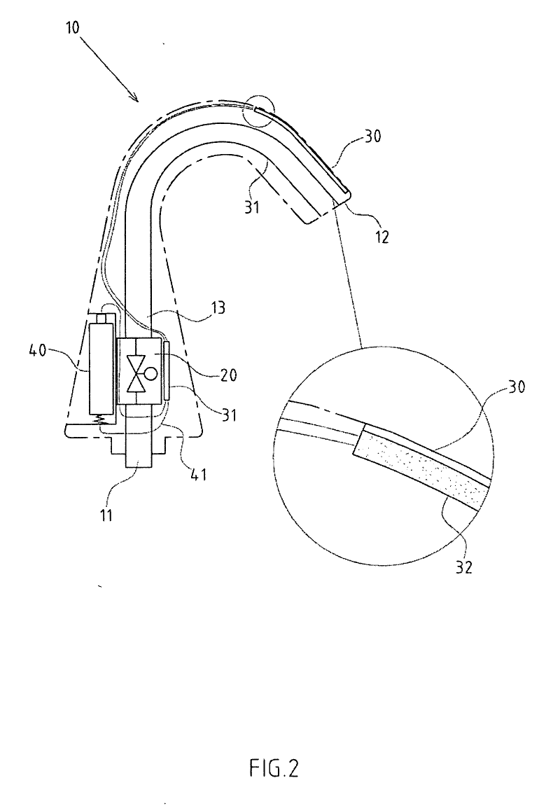

As shown in FIGS. 1-2, there is a preferred embodiment of the touch-flow water supply apparatus.

The invention includes a water supply apparatus 10, the water supply apparatus of the embodiment being a faucet, which includes a water inlet 11 and a water outlet 12.

There is an electronic control valve 20, which can be electronic-magnetic valve, it can be placed on the channel 13 between the water inlet and outlet 11 12 of the water supply apparatus.

The invention also includes a touch sensory controller 30, which can be placed on the water supply apparatus 10 for people's hands to touch and operate.

A circuit controller 31 connects the electronic control valve 20 and touch sensory controller 30, and it converts the touch sensory signal of the touch sensory controller to controlled current to control the switch of the electronic control valve 20.

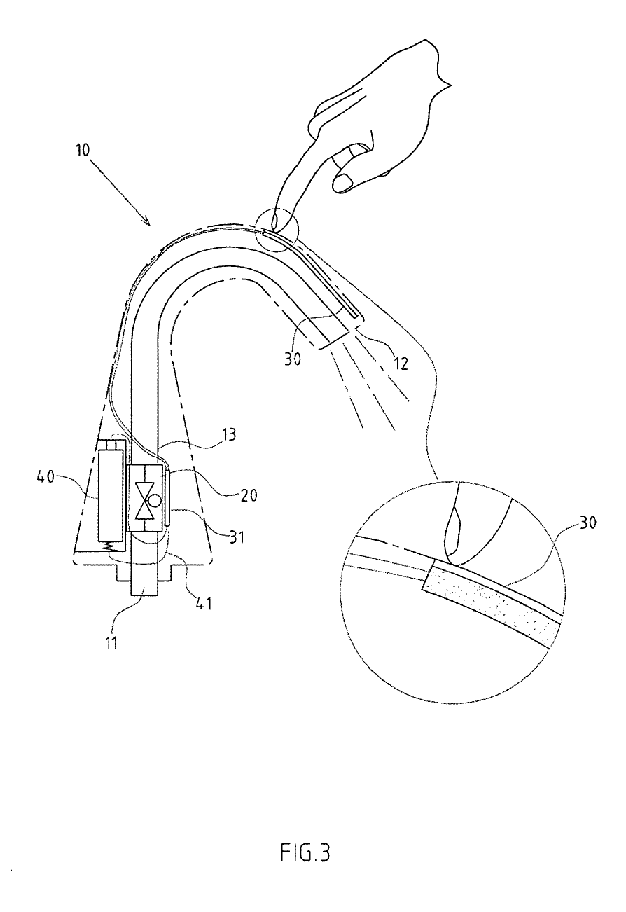

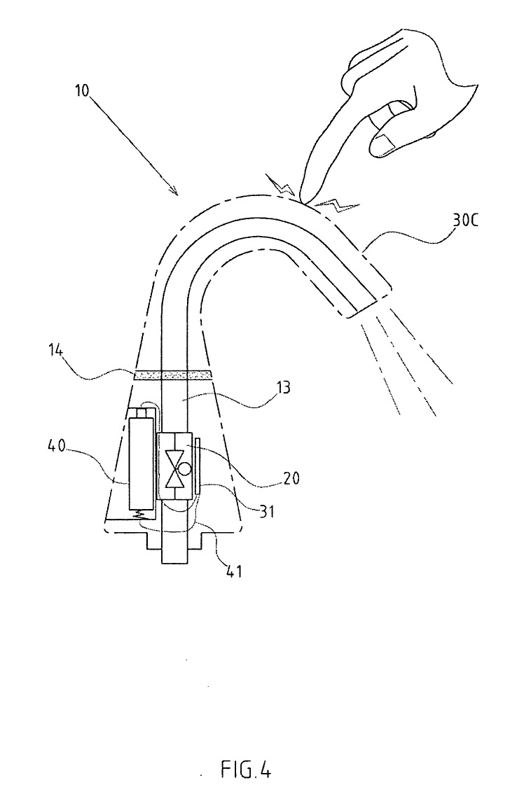

Among them, the touch sensory controller 30 may be placed on the water supply apparatus 10 (it is placed on the top of the water outlet of the faucet); and the touch sensory controller 30 mentioned above as revealed in FIGS. 1-3 can be a structure with touch sensory (such as touch sensory panel structure), and by so doing, the user can touch the touch sensory controller 30 with their hands to control the on and off status of the water; or the touch sensory controller 30B shown in FIG. 4, which is a static electricity switch control, and it covers the top half of the water supply apparatus 10 within the scope of static electricity, and insulates the bottom half of the water supply apparatus 10 from the touch sensory controller 30B, and by so doing, the users can touch any part of the top half of the water supply apparatus 10 to control the water.

A power supply 40 is connected to the circuit controller 31 through circuits, and it provides power needed for the electronic control valve 20, touch sensory controller 30 and circuit controller 31 mentioned before; among them, the power supply 40 disclosed in this embodiment can be a set of battery placed in the water supply apparatus 10; moreover, the power supply mentioned above can be an external power connection (such as plugging the plug on the AC outlet).

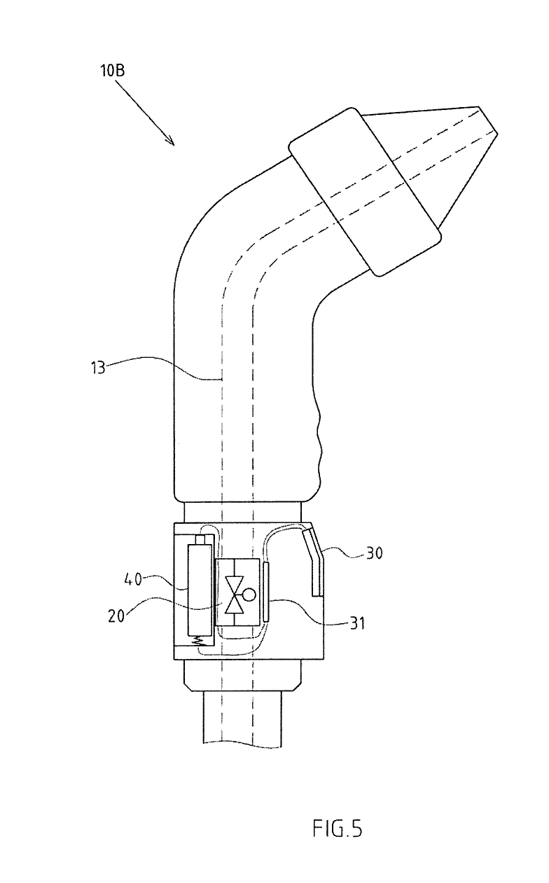

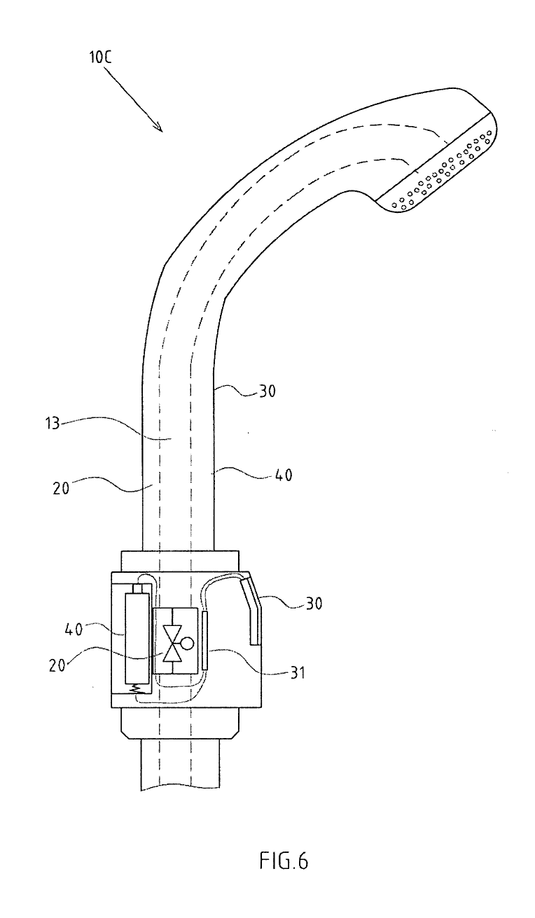

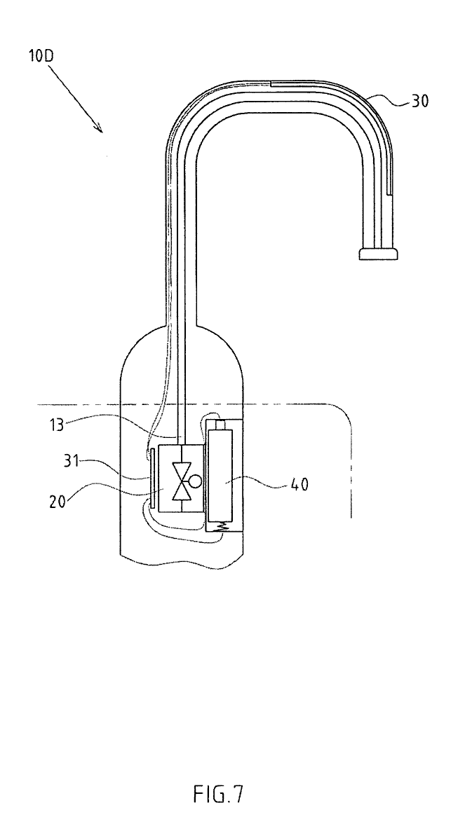

Among them, besides the water supply apparatus 10 can be a faucet, it can also be the water supply apparatus 10B, which is a spray gun, as shown in FIG. 5; or it also can be the water supply apparatus 10C, which is a shower nozzle, as shown in FIG. 6; or it can also be the water supply apparatus 10D, which is a gooseneck faucet, as shown in FIG. 7.

Through the above structure and design, the water supply apparatus 10 of the present invention as shown in FIG. 2 3 can control the water by operating the touch sensory controller 30; for a more concrete operational view, by touching the circuit controller 31 set for touch sensory controller 30 when using the touch sensory controller 30, press once to turn on the water, and press once more to shut off the water.

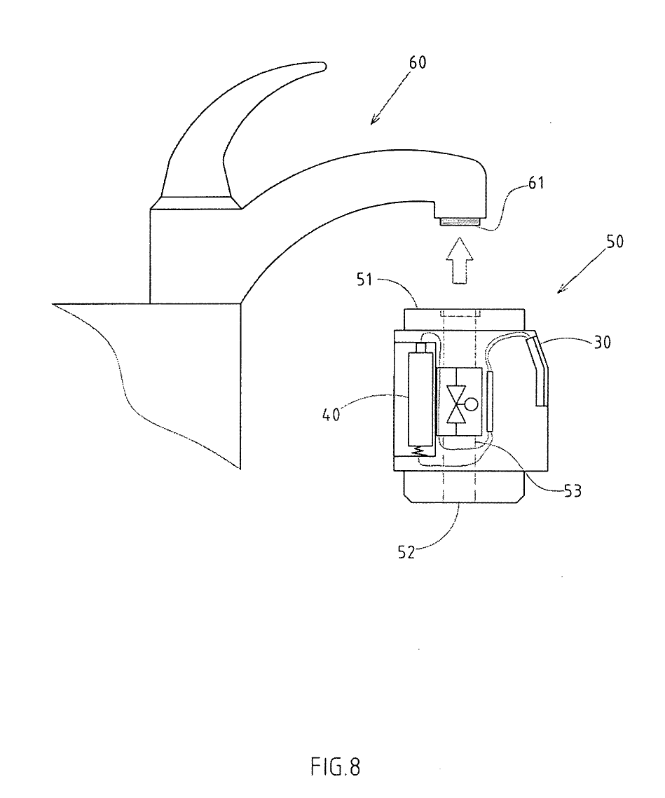

As shown in FIG. 8, which is another embodiment of the present invention, and the structure is different than the water supply apparatus 50 with touch-flow device, and it can be added to the existing water supply unit 60 (a faucet in this embodiment), among them, the entire water supply apparatus 50 can be a cover, which includes a connector 51 that can be connected to the water outlet 61 of the existing water supply unit 60, and a water outlet 52 on the other end of water supply apparatus 50 is connected to the connector 51 mentioned above through channel; place the electronic control valve 20 on the channel 53 between the connector 51 of the water supply apparatus 50 and water outlet 52; by controlling the touch sensory controller 30 that controls the electronic control valve 20 switch, circuit controller 31, and the power supply 40 for providing power needed is placed the water supply apparatus 50; this embodiment can be added on the existing water supply unit such as faucet) to achieve the practical function of touch-flow control.

As shown in FIG. 8, which is another embodiment like the structure mentioned above; the water supply unit mentioned early is a spray gun 60B in this embodiment, and add the water supply apparatus 50 on the inflow end 62 of the spray gun, and by so doing, it can use the operating feature of touch sensory controller 30 of the water supply apparatus 50 to achieve the practical function of touch-flow control. (Note: The switch 63 of the spray gun can be set on ON status when using.)

I claim:

1. A touch-flow water supply apparatus comprising:
a water supply apparatus having a water inlet and a water outlet;
an electronic control valve, placed on a channel between the water inlet and water outlet of the water supply apparatus;
a touch sensory controller, placed on the water apparatus for a hand of a user to touch;
a circuit controller, connecting the electronic control valve and touch sensory controller, and converting a touch sensory signal of the touch sensory controller to controlled current to control the switch of the electronic control valve; and
a power supply, connected to provide power needed for the electronic control valve, touch sensory controller and circuit controller.

2. The touch-flow water supply apparatus defined in claim 1, wherein said water supply apparatus is comprised of a faucet, spray gun, shower nozzle, water channel and water outlet.

3. The touch-flow water supply apparatus defined in claim 1, wherein said electronic control valve is comprised of an electromagnetic valve.

4. The touch-flow water supply apparatus defined in claim 1, wherein said touch sensory controller is touch-flow.

5. The touch-flow water supply apparatus defined in claim 1, wherein said power supply is comprised of a battery set placed on the water supply apparatus.

6. The touch-flow water supply apparatus defined in claim 1, wherein said power supply is positioned externally.

7. A water supply apparatus of the water supply unit comprising:
a connector connected to the water outlet of the water supply unit, the other end thereof being connected to said connector;
an electronic control valve placed on the channel between a water inlet and water outlet;
a touch sensory controller placed thereon and being touchable by a hand of a user;
a circuit controller, connecting said electronic control valve and touch sensory controller, and converting a touch sensory signal of the touch sensory controller to controlled current to control the switch of the electronic control valve;
a power supply connected to provide power needed for the electronic control valve, touch sensory controller and circuit controller.

8. The water supply apparatus of the water supply unit defined in claim 7, wherein said electronic control valve is comprised of an electromagnetic valve.

9. The water supply apparatus of the water supply unit defined in claim 7, wherein said touch sensory controller is touch-flow.

10. The water supply apparatus of the water supply unit defined in claim 7, wherein said power supply is comprised of a battery set placed thereon.

11. The water supply apparatus of the water supply unit defined in claim 7, wherein said power supply is positioned externally.
